(19) United States
(12) Patent Application Publication
(10) Pub. No.: US 2006/0117709 A1
(43) Pub. Date: Jun. 8, 2006

(54) Returnable package, method for the production thereof and method for embodying a returnable package system

(76) Inventors: Matthias Niggemann, Berlin (DE); Oliver Muth, Berlin (DE); Manfred Paeschke, Basdorf (DE); Andreas Deichsel, Berlin (DE); Rainer Seidel, Berlin (DE); Arnim Franz-Burgholz, Falkensee (DE); Hans Zerbel, Berlin (DE)

Correspondence Address: Kriegsman & Kriegsman, 665 Franklin Street, Framingham, MA, 01702, US

(21) Appl. No.: 10/524,694

(22) PCT Filed: Oct. 30, 2003
(86) PCT No.: PCT/EP03/12091

§ 371 Date: Nov. 3, 2005

(30) Foreign Application Priority Data
Nov. 13, 2002 (DE) 102 53 096.3

(51) Int. Cl. B65B 61/00; B67B 3/00

(52) U.S. Cl. 53/410; 53/471

(57) ABSTRACT

The invention relates to a returnable package provided with at least one deposit mark, a method for producing said returnable package provided with at least one deposit mark (12) and a method for implementing a returnable package system. The inventive method for implementing the returnable package system consists of providing a recyclable object with at least a first irremovable safety sign (14) and in applying at least one another irremovable safety sign to the object which is provided with at least the first irremovable safety sign (14) before, during and/or after the introduction of a product into said returnable object. The issue of the other safety sign is predefined by a command which is inaccessible for the producer of the returnable package (11). Afterwards, the returnable value for a returnable mark (12) is generated by the combination of at least said first and other safety sign (14, 16).

The present invention relates to a returnable package having at least one deposit mark, a method for its production and a method for implementing a returnable package system. These returnable packages are generally provided for a material circulation in which the package on which a deposit is to be charged or the object on which a deposit is to be charged is reused or recycled.

Returnable package systems are already known. The returnable package or the object on which a deposit is to be charged comprises a container or a package, such as a plastic bottle or a glass bottle, which is filled. When the returnable package is sold, the customer pays a deposit in addition to the purchase price of the product. After the product has been used up, the object on which a deposit is to be charged is handed back and the deposit is returned.

Returnable package systems of this type have proven to be suitable as a result of the reuse of the object on which a deposit is to be charged. Furthermore, resources can be saved to a considerable extent.

The occurrence of disposable or double-use products which are recyclable has grown sharply. The disposable or double-use products, which are designated with disposable products in the following text, are normally not used as such after they have been returned to the manufacturer but fed back into the material circuit of the product production process.

In order to give the purchaser of returnable packages and incentive to hand these back to the manufacturer in the case of disposable products, in order thus possibly to close the material circulation, it has been proposed to apply the deposit system known in returnable systems to these objects as well. In the returnable system, the deposit usually corresponds to the value of the object. Since the value of disposable products is, however, normally so low that a deposit which corresponds to its actual value would not offer the consumer any incentive to return objects, a deposit which is common in returnable systems or even one which is still higher is proposed. Since the amounts of the deposits no longer correspond to the value of the object on which a deposit is to be charged, this provides an incentive to misuse by issuing packages on which no deposit is to be charged or which do not belong to the material circuit.

DE 199 06 255 A1 has disclosed an object on which a deposit is to be charged and a method for its production by means of which it is intended to ensure that there is monitoring both over the number or returnable objects put into circulation and those actually returned to the system. For this purpose, a material circulation system is proposed which is monitored by a clearing authority. The requirement for the security of deposit marks and of the returnable package system and the risk of misuse and manipulation of objects on which deposits are to be charged has risen further, so that further security-relevant precautions are required.

The invention is therefore based on the technical problem of providing a returnable package having at least one deposit mark and a method for the production of such returnable packages and also a method for implementing a returnable package system, by means of which a high level of security against forgery is provided for the at least one deposit mark and the production of the at least one deposit mark can be integrated simply in existing fabrication technologies, and which permits an increase in the security of a returnable package system.

This basic technical problem is solved by a method for producing a returnable package having at least one deposit mark as claimed in claim 1 and by a method for implementing a returnable package system as claimed in claim 19, and by a returnable package as claimed in claim 38. Advantageous developments of the invention are specified in the subclaims.

The invention provides for the returnable package to comprise at least one deposit mark, in which at least two security features are provided, in order to form the deposit mark so as to be forgery-proof. At least one first security feature, which forms a first component of the deposit mark, is provided on the object on which a deposit is to be charged, which is provided with consumer goods, consumable articles, foodstuffs or the like. The at least one security feature is applied before, during and/or after the introduction of goods into the package on which a deposit is to be charged and which is provided with the at least one security feature, and forms at least one second or further component of the forgery-proof deposit mark.

As a result of the separate assembly of a first and at least one further security feature for a deposit mark, both from a material and from a fabrication point of view, it is made possible for the individual security features for a deposit mark, which as such have no value, only after the assembly of the at least two security features a valuable and forgery-proof deposit mark is created. The risk of manipulations is reduced. For this purpose, the invention further provides for the at least one security feature, which is applied during the production of the returnable package and is combined with the at least one first security feature, to be carried out via a control unit that is not accessible to the manufacturer of the object on which a deposit is to be charged. The issue of the at least one further security feature is monitored by at least one clearing authority, so that a further security precaution relating to the production and assembly of at least one deposit mark is provided.

The return package according to the invention having at least one deposit mark, and also the method for its production, thus have the advantage that the generation of the value of the deposit mark is preceded by a separation of the deposit feature constituents or the security features, which are assembled only during the production or in the final fabrication of the object on which a deposit is to be charged, so that, until the assembly of the security features, each individual security feature of a deposit mark has no value. At the same time, the application of the at least one security feature for generating the deposit value is controlled and monitored, since improper charging of deposits on disposable products includes a generation of value corresponding to the disposable product.

In the sense of the invention, substantially irremovable security features is understood to mean that the deposit mark is not removed from the returnable package during normal use and handling of the latter. Removal is envisaged during the recycling process.

An advantageous refinement of the invention provides for at least one first and a further security feature to comprise at least one item of information for detection of the authenticity or the membership of the returnable package of the system in relation to the material circulation system. As a result, the material circulation can be secured, so that returnable packages not belonging to the system are detected and no deposit is repaid during the attempted return.

Furthermore, the storage of the amount of the deposit is provided by means of at least one security feature, so that, for example, in the event that a deposit value printed on optically is worn away, the actual deposit for the returnable package is repaid. Furthermore, the application of the security features as information at least in relation to the authenticity or additionally with the amount of the deposit also provides security for the different deposit systems in different regions. As a result, returnable packages from one state can be returned in another state, the detection of authenticity or of the membership of the system representing a first security check and the deposit actually stored being returned as a result of the detection of the amount of the deposit. The used returnable packages can be repurchased by a large number of repurchasing points witch, for example, are monitored by a clearing authority. This clearing authority, for example a national clearing authority, can in turn be connected to a national clearing authority of another state or a higher-order clearing authority extending beyond a region, so that, for example, when a deposit for a returnable package from another state is returned, it is possible to balance the different levels of deposit and to interchange data about the accepted returnable packages via the clearing authority of the individual repurchasing points. As a result, within each material circulation system, complete monitoring can be provided, at the same time it being possible to provide a repurchasing system which extends beyond regions and even beyond systems. The flexibility of the material circulation systems is thus increased without security being impaired.

According to an advantageous refinement of the invention, provision is made for at least one security feature to be formed as an open feature. An open security feature is understood to mean what are known as public features, which are visible or can be detected without aids. This can be, for example, a bar code or else the imprint of the deposit value, a deposit logo or the like, and also information that can be detected by sensory means, such as elevations, depressions, grooving or the like.

According to a further advantageous refinement of the invention, provision is made for at least one hidden or concealed security feature to be provided, which can be read only by means of aids. These security features can, for example, be detected with simple aids for the purpose of verification upon manual return. For example, these security features can comprise UV-fluorescence and/or phosphorescence, so that simple UV testing instruments can be used and the security feature can be made visible thereby.

According to a further advantageous refinement of the invention, provision is made for at least one security feature to be formed as a machine-readable security feature and to form what is known as a high security feature. Security features of this kind can comprise the entire electromagnetic spectrum, such as pigments or materials that can be registered visually, by UV and/or by IR, or pigments having, for example, short decay times, which are provided in a substance or a material for forming the security feature. Likewise, it is also possible to provide materials whose optical, electrical and/or magnetic properties can be detected. These pigments or materials can also be provided in a wall of the object on which a deposit is to be charged. The machine-readable features are preferably used for the purpose of verification during mechanical repurchase of the returnable package on automatic repurchasing equipment. In addition, open information can be read in this repurchasing equipment.

The at least one security element which comprises concealed features is preferably transparent, translucent, phosphorescent, fluorescent, luminescent, UV-emitting and/or IR-emitting. Further suitable materials for the configuration of the at least one security feature are possible.

For example, a suitable security feature comprises substances in the form of Stokes pigments, that is to say luminescent pigments having an emission wavelength which is higher than the excitation wavelength. Furthermore, the security features can comprise anti-Stokes pigments. Likewise, a combination thereof can also be provided.

Inorganic and/or organic security pigments of this type are preferably provided, since these exhibit excellent fastness to light, resistance to chemicals, resistance to heat, resistance to moisture and, given an appropriate selection of the pigments, can be displayed only with extreme difficulty or with a very high and appropriate level of know-how. Furthermore, security pigments of this type exhibit good possible integration in different application processes in terms of concentration and with a controlled amount or controlled volumes, so that fast and secure detection and verification, including control of quantity, is possible.

According to a further advantageous refinement of the invention, provision is made for the at least one security feature to have fluorescent security pigments with a decay constant which is very short, so that a response signal can be obtained only for a very short time during the authenticity verification.

The deposit mark is advantageously formed by at least one security feature having at least one item of open information and/or at least one item of concealed information. A first basic safeguard for the deposit mark is formed by the use of, for example, at least two items of open information belonging to the security features. As a result, the deposit mark can be verified, at least during a manual return. In order to increase the security of the deposit mark, at least one open and at least one concealed item of information are advantageously applied. Verification, at least during manual return, is to be made possible by the use of very simple aids.

A further increase in the security against forgery of a deposit mark is provided by the use of an open item of information and at least one item of concealed information formed as machine-readable information. Items of concealed information of this type are very complicated to produce and their manipulation at the time of verification is very difficult. Depending on the desired security against forgery, the superimposition of one or more open and/or concealed items of information can also be provided. The open information can at the same time contain further information, such as the type of material on which a deposit is to be charged, the amount of the deposit, the date on which the deposit was charged, date of manufacture, best-before information or the like.

According to a further advantageous refinement of the invention, provision is made for the at least two security features to be output as a function of each other. For example, during the production of beverages, at least one security feature is applied directly by the filler. Both the high production speeds and the production conditions require specific adaptation of the security features so that their application is ensured. To this extent, different techniques in the application of the security features can be coordinated with one another as required, depending on the production or filling process of the object on which a deposit is to be charged. Thus, different techniques for the security feature can be combined with one another.

Advantageously, provision can be made for the first security feature and the at least one further security feature to have at least partly coincident information. By means of this redundancy, simple and rapid verification of the two security features can be provided at the time of repurchase. Furthermore, provision can advantageously be made for the information or information from the first security feature and from the at least one further security feature to supplement and/or superimpose each other, so that an additional increase in the security against forgery and, respectively, an increase in the effort for misuse is provided.

In an advantageous embodiment, at least one security feature is provided directly on the object on which a deposit is to be charged. For example, in the case of containers such as plastic bottles or glass bottles or the like, direct printing can be carried out. The at least one security feature can be applied directly or indirectly to the object on which a deposit is to be charged. For example, security features can be provided on labels, closures of containers, can lids, decorative prints or the like, which can, moreover, be applied indirectly to objects on which deposits are to be charged.

The at least one further security feature is preferably applied following the completion of the production of the object on which a deposit is to be charged, in particular by means of direct marking. The content to be sold is provided in the object on which a deposit is to be charged and, after the object on which a deposit is to be charged has been closed completely, the at least one further security element is preferably applied, directly or immediately. As a result, it is additionally possible to achieve the situation where the generation of a deposit value is carried out only after the satisfactory completion of the production process.

The at least one further security feature is, for example, applied to the returnable package in an inline process. As a result, economical integration relating to the application of the deposit mark and also securing the deposit can be provided in the production process. In the case of an inline process, for example at a filler, directly successive operations, such as bottle cleaning, printing or labeling, filling, closing and packaging, are carried out, the bottles being transported substantially continuously on a conveyor belt.

Moreover, according to the invention, a method of implementing a returnable package system is proposed, in which in particular a method for producing at least one returnable package having at least one deposit mark is provided, which has at least one first and a further security feature, whose deposit value is generated by the combination of the security features.

In order to apply the at least one further security feature, a marking unit is provided. This marking unit is not accessible to a manufacturer or seller of returnable packages. The issue advantageously takes place following the detection of a returnable package by a sensor. As a result of this measure, misuse is already made more difficult.

Advantageously, the at least one further security feature is applied by a marking unit which receives from a control unit a clock pulse which is derived from the conveying speed of the object with a deposit value and/or its spacing. As a result, each object on which a deposit is to be charged is provided with a further security feature, which generates the value of the deposit mark.

In order to monitor the value generation, provision is advantageously made for each issue of a security feature to be monitored by a control unit, passed on to a data-processing system and at least partly stored. The marking unit has a reader connected downstream, by means of which the at least further security features applied are registered. This data is likewise passed on to a data-processing system, which is preferably on the premises of the manufacturer or filler, and at least partly stored. At the same time, monitoring of the security features actually and properly applied can be provided.

At least the marking unit and the reader of a security system are preferably arranged at a short distance from each other, for example fewer than three meters are envisaged in a bottle or can filling plant. As a result, secure reading of the mark applied can be provided, even for the case in which at least partial rotation of the bottle, the can or the like were to take place on account of the transport conveying direction.

According to a further advantageous refinement of the invention, provision is made for the at least one further security feature to be applied without contact by the marking unit to the object on which a deposit is to be charged. As a result, even at very high conveying speeds, a security feature can be applied to the returnable package. Alternatively, direct marking can also be carried out by means of the application of ink by means of roll printing, pad printing or the like.

In the marking unit, the number of security features issued and the mass and/or the volume of the marking medium issued are preferably evaluated and stored. This storage is advantageously carried out both in a memory element arranged on a container of the marking medium and in the marking unit or the associated data-processing system. The containers provided with the data are verifiably replaced after being emptied and are transferred in a secure manner to a security provider for filling. In addition, the replacement of the containers with marking medium, the rolls or the like for direct application is registered, so that the transport paths and also the number of containers in circulation are known and can be checked. Advantageously, the data registered by the manufacturer or the filler in the data-processing system, which data is not accessible to the manufacturer, is transmitted to a neutral authority (clearing authority) monitoring the entire returnable circulation. In parallel with this, it may be necessary for the security provider likewise to transmit the production-relevant data read from the containers to the clearing authority for comparison, or for the security manufacturer to check the information and data from the manufacturer or filler and the clearing authority for their plausibility.

The plausibility check advantageously carried out by the security provider takes account of a minimum quantity of data, in order to permit or to increase the safeguards of the returnable package system.

At least the number of security features issued is monitored. Depending on the configuration of the security features, further data can be monitored. For instance, when a marking medium is used, in addition to the number of security features applied and affixed, the quantity and/or the mass of the marking medium can alternatively or additionally be monitored.

Furthermore, provision is advantageously made to ensure on the returnable packaging system that, as early as during the production of the security feature, in particular during the production of marking medium, monitoring with respect to the quantity is carried out. Further monitoring is advantageously provided in that the quantity produced is filled or packed into containers provided. These containers are also in turn checked and monitored with respect to their number and completeness. Provision is advantageously further made for these containers to be coded, so that the transport path from the security provider to the filler or manufacturer can also be monitored and controlled. Advantageously, the security features to be applied or the components for forming security elements are manufactured or prepared or assembled at the security provider, so that monitoring is made possible as early as during the first step for the production of components of the security features.

The deposit mark can be formed by any desired selection of the security features described previously and listed below. The deposit mark comprises at least two security features and can have an application-specific higher number of security features. Moreover, provision can be made for further individual security features to be applied in addition to the at least one deposit mark. In this case, these can be additional control points of verification features. Likewise, further information can be stored.

The invention and further advantages and embodiments and developments of the same will be described and explained in more detail in the following text using the example illustrated in drawing. According to the invention, the features to be gathered from the description and the drawing can be applied individually on their own or in a plurality in any desired combination. In the drawing:

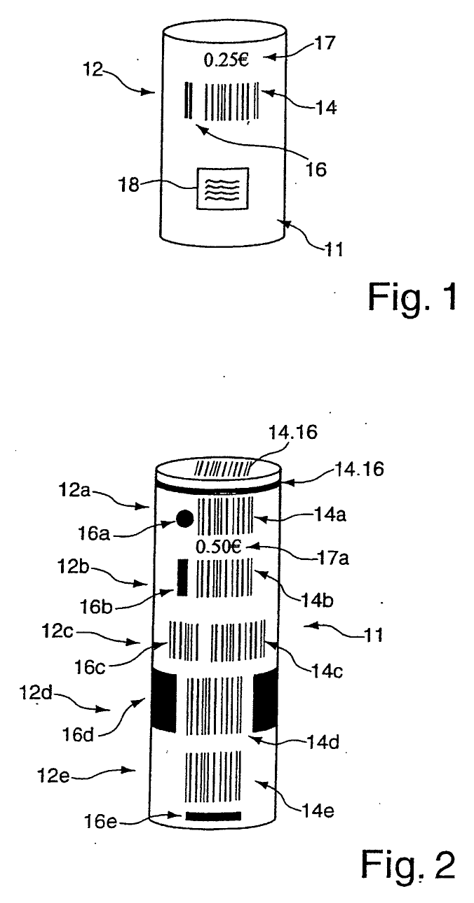

FIG. 1 shows a schematic illustration of a returnable package according to the invention having a deposit mark,

FIG. 2 shows a schematic illustration of a returnable package having a large number of different possible embodiments of the deposit mark,

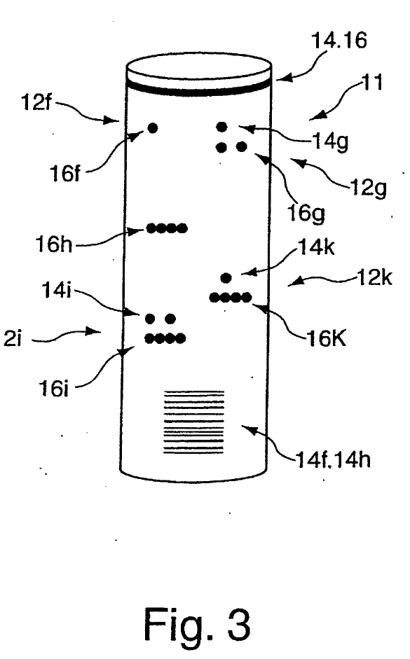

FIG. 3 shows a schematic illustration of a returnable package according to the invention having alternative possible applications of a deposit mark,

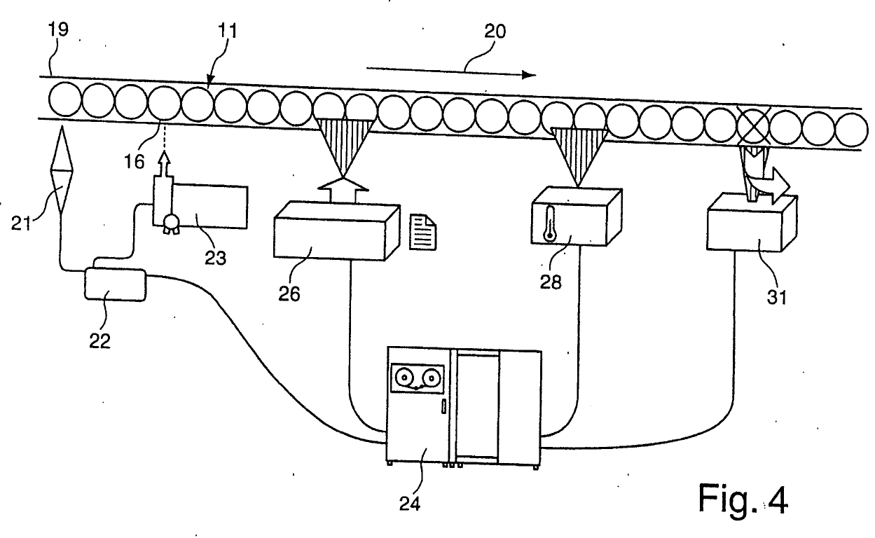

FIG. 4 shows a schematic illustration of a generation of the deposit mark in an inline process and safeguarding the application of the security feature, and

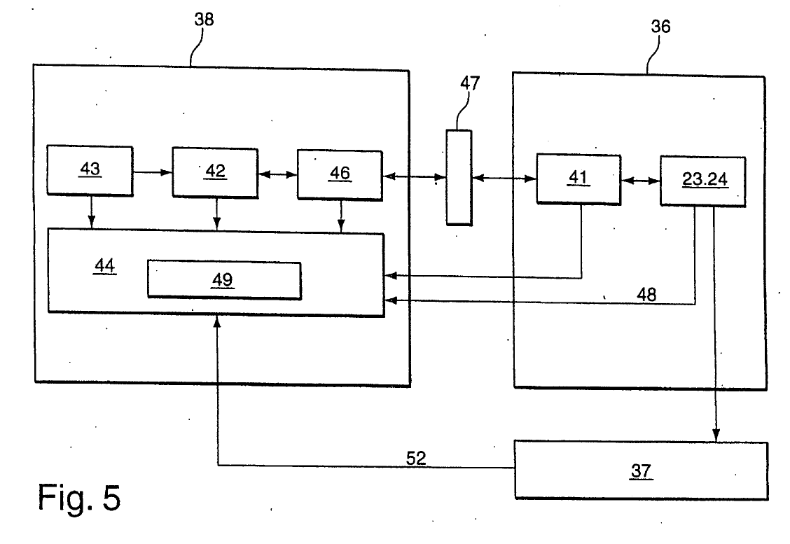

FIG. 5 shows a schematic illustration of part of a returnable package system for the deposit marking of returnable packages.

In FIGS. 1 to 3, a returnable package 11 having a deposit mark 12 is illustrated schematically. The returnable package 11 can comprise a container or package, in particular a can made of plastic or tinplate, a bottle made of plastic or glass, a glass or plastic container, a carton or multilayer package made of paper, board, paperboard, wood, plastic, aluminum, tinplate, textile fibers, textile fabrics and/or further composite materials, in which liquids, foodstuffs, consumables or goods of a general type are provided.

The returnable package 11 is produced as a disposable product made of recyclable material. The deposit mark 12 applied to the returnable package 11 comprises a first security feature 14 and at least one further security feature 16. The first security feature 14 is formed as an item of open information or code, for example as a bar code. The further security feature 16 is formed as an item of hidden information or code which can be verified by means of aids. In addition, the deposit mark can have a statement relating to the deposit value 17 which can be detected visually. Furthermore, a deposit logo 18 can be provided. The first and further security features 14, 16 are not restricted to the embodiment illustrated but can, moreover, also contain information about the deposit value, the deposit logo or further details.

FIG. 2 illustrates a returnable package 11 having various possibilities relating to configuring deposit marks 12a to e with the security features 14a to e, 16a to e. The at least one further security feature 14, 16 can be applied to the returnable package 11, preferably directly, in the form of at least one point, a rectangle and also a bar code. Likewise, a peripheral ring or peripheral band can be provided. Furthermore, different geometric forms can be used as a code for the deposit package 11, being assigned to one another in an extremely wide range of ways and being capable of being combined with an open security feature for coding, for example a bar code.

FIG. 3 illustrates by way of example the arrangement of deposit marks 12f to k which have security features 14 and 16 with one or more points at a different distance and in different numbers in relation to one another. Each grouping on its own or the individual points in relation to one another can represent at least one first and/or at least one further security feature 14, 16, any desired combination of open and concealed security features 14, 16 being possible. The material for the security features 16 generally comprises a polymer matrix, whose actual configuration can be provided in an extremely wide range of forms. The security marking matrix used for the security features is preferably transparent or partially transparent or translucent or transparent to the reading wavelength and is matched to the respective marking method with or without contact so that adequate abrasion resistance, resistance to heat, light, moisture, chemicals and further environmental factors is provided. All types of inorganic and organic pigments can be used in order to configure the security feature.

Likewise, on their own or in combination, a letter-number arrangement or a code in the form of 1-D or 2-D or 3-D codes can be provided, which are formed as further security elements 16.

The at least two security features 14, 14 or 14, 16 or 16, 16 or any desired multiple combination which form a deposit mark 12, comprise at least one item of information about the authenticity of the returnable package 11. In addition, information about the amount of the deposit can be predefined. Both are preferably provided in a forgery-proof manner in order to form a deposit mark 12. It is also possible for further useful data to be deposited in the security features, if this is necessary or desired. In open codes, it is usual for necessary or useful data, such as the system operator, the type of material, the manufacturer, the batch identifying numbers, the date at which the package was put into circulation, best-before dates, prices of the returnable package, is provided. The hidden items of information advantageously form the security or high security features.

FIG. 4 illustrates part of a security system for the application of the at least one further security feature 15, which is part of an entire deposit securing system or an overall deposit system, for example illustrated in FIG. 5.

FIG. 4 illustrates, by way of example, the assembly of an at least further security feature 16 in a production process with an at least first security feature 14, which has already been applied to a returnable package 11.

In the following text, the generation of the deposit value will be explained in more detail using the example of a filling process of liquids according to FIG. 4, the following description not being restricted thereto.

The at least one first security feature 14 can be printed following the manufacture of the bottle or can, by means of direct printing of a bar code into the decoration of the can or bottle. Alternatively, provision can be made, instead of direct printing, for the at least first security feature 14 to be introduced on labels on decorative sleeves which are fitted to the can or bottle. In the case of can production, provision can, moreover, alternatively be made for the at least one first security feature 14 to be applied to each lid of the cans. Likewise, instead of the lids of the cans, crown corks, bottle closures or the like can be provided for the application of the first security feature 14.

After the can or bottle has been filled with liquid and closed, the application of the at least one further security feature 16 is carried out in order to generate the value of the deposit mark 12. This value generation comprises a plurality of security-relevant steps and procedures in order to prevent manipulations, as explained by way of example in the following text.

The returnable package 11 transported in the transport direction 20 on a conveyor belt 19, such as the bottle or can to be marked, is registered by a sensor 21. The sensor 21 can be formed as a photocell and incremental encoder for registration. This sensor 21 passes on a signal to a control unit 22, in which a clock pulse for a marking command is output to a marking unit 23. The clock pulse depends on the conveying speed (for example 0.1-10 m/s) and the diameter or the size of the objects on which a deposit is to be charged, which are lined up one after another. There then follows a preferably non-contact application of at least one further security feature 16 to the returnable package 11. The marking unit 23 in turn sends a signal about the issue of a security feature that has been carried out to the control unit 22, which passes on the data from the sensor 21 and the marking unit 23 to a data-processing system 24.

The at least one further security feature 16 is applied as a direct mark to the object on which a deposit is to be charged. This at least one further security feature 16 comprises concealed items of information. The at least one further security feature 16 can be applied at any desired points of the object on which a deposit is to be charged. Provision is preferably made, following the complete filling of a can or bottle, for the at least one further security feature 16 to be applied to an outside in the belly or neck region of the can or bottle. Alternatively, provision can be made for the at least one first security feature 14 to be applied directly to the bottle or can and indirectly to the bottle or can and, after the filling of the bottle or can, for a closure to be supplied for the bottle or can, which are provided with at least one further security feature 16. When the can or bottle is closed, at the same time the assembly of the security features 14, 16 for generating the deposit is made possible. The at least one further security feature 16 is applied to the closure or lid of the object on which a deposit is to be charged in a process the security of which is monitored.

In the exemplary embodiment, the marking unit 23 accommodates at least one replaceable container which contains the marking medium. The marking medium can be liquid or of high or low viscosity.

Alternatively, the marking unit 23 can also be designed to accommodate at least two containers, the marking medium being discharged from the containers by a dispensing unit. Furthermore, in each case a dispensing unit for discharging security features can be provided on each container. Furthermore, the marking unit can have at least two dispensing units, to which in each case one or more containers can be assigned. In order to increase the security relating to the application of the at least one further security feature 16, provision can also be made for two marking units 23 to be used. Any desired combination of the abovedescribed embodiments relating to the application of the at least one further security feature 16 is possible.

Alternatively, devices such as a roll or the like for a direct application can also be provided. The container according to the exemplary embodiment in turn has a memory element in which data is stored, such as individual code of the container, time at which the container was inserted into the marking unit, identification of the marking unit and start of consumption, and also number of marks issued. All this data is likewise passed on to the data-processing system 24 and at least partly stored by the latter.

The non-contact marking of the marking unit 23 has the advantage that this can be employed universally, in particular in an inline process. Furthermore, high application speeds may be possible, which are necessary in particular in can production. The non-contact application causes negligible wear, since there are very few moving parts in the marking unit 23. By means of the non-contact marking, different forms and patterns and also arrangements of marks can be applied to returnable packages 11 at high conveying speeds. Furthermore, a small volume of liquid is possible in order to create a mark. Marking systems of this type also have the advantage that they are closed and manipulation-proof interchangeable container systems which can be inspected and monitored.

Provided after the marking unit 23 is a reader 26 or a scanner, which inspects and logs the at least one further security element 16 applied and passes this information on to the data-processing system 24. The reader 26 is preferably spaced apart from the marking unit 23 at a very short distance, for example less than 3 m, in order to permit the inspection function, therefore generally the verification of the codes or security features applied, without the returnable package 11 rotating away. At the same time, faults or non-marking is also detected. These lead to bottles or cans that have not been marked completely being sorted out via a sorting unit 31. Between the reader 26 and sorting unit 31, a level inspection system 28 is preferably provided, in order to check whether quality deficiencies or non-compliance with at least one quality deficiency of the goods is present. This level inspection system 28 can likewise be provided before the sensor 21, in this arrangement a signal which prevents the issue of further security features 16 preferably being given to the data-processing system 24 or the control unit 22 relating to the level inspection 28 in the event of quality deficiencies.

The distance between the sensor 21, the marking unit 23, the reader 26, the sorting unit 31 and, if appropriate, the level inspection system 28 is preferably short. As a result, secure application of the deposit values and inspection can be provided. Furthermore, the integration and assignment of part of the deposit securing system to an inline process can be carried out in a small space. The distances between two successive components 21, 23, 26, 31 and, if appropriate, 28 in each case are amount to preferably less than 3 m.

The individual components, such as the sensor 21, the marking unit 23, the control unit 22 and the reader 26, can be provided as a whole or in any desired combination in a station or in a unit or in a housing, which can be positioned at any desired point in relation to conveyer belt 19.

Both the storage of the data in the data-processing system 24 and the storage of the data in a memory of the container for the liquid marking medium permit the process sequence to be secured during the filling and production of the containers and their tailoring, and also during the replacement of the containers for the marking unit 23 and their transport, as will be explained in more detail in the following text.

For security against misuse and the introduction of return packages 11 not belonging to the system, a security system for a returnable package system is provided which, according to the exemplary embodiment in FIG. 5, comprises a filler 36, a clearing authority 37 and a security provider 38. The filler 36 can be understood to mean any further manufacturer who produces disposable products which are taken into the material circuit and are to be provided with a deposit value or a deposit mark 12. The clearing authority 37 is a monitoring authority of the returnable package system and can be set up by an association, by the government, the region or another central point or authorities and also by a company. A security provider 38 monitors and coordinates the production of at least one security feature 16, preferably a high security feature, which is used at the filler 36 to generate the value of the deposit mark 12. At the same time, the data is prepared and compared and coordinated with the clearing authority 37 and to ensure that the number of deposit marks 12 produced and issued also corresponds to a deposit value which is in circulation.

The security provider 38 produces the containers with marking medium for the application of the marking (designation 42). Both the production of ink 43 and the production of the containers are monitored, registered and reported in parallel to an EDP-based management system 44. The production of the inks, containers or further materials for the application of the security feature can be carried out by security provider or monitored externally. For each container, a specific code is allocated for the purpose of individualization (designation 46). For this purpose, an EDP-based management system 44 controls and documents each operation. If a requirement from filler 36 for containers for applying the marking is requested, the filler 36 receives the individualized containers via a secure transport route 47. In the management system 44, the number of containers issued is noted. Likewise, the requests and the numbers of containers requested are stored in the data-processing system 24 of the filler 36. A filler 36 receives the containers in a verifiable manner and stores these in a secure-access region 41. Depending on the production, the containers are removed from the secure-access region 41 in a verifiable manner and installed in the marking unit 23 of the production line. By means of the use of, for example, two containers which are installed simultaneously in the marking unit 23, a redundant system is created which, in the event of any possible failure of a container, makes it possible to change over immediately to the other container.

This changeover is likewise stored. As soon as a container is empty, an appropriate message is given to the data-processing system 24, which leads to the replacement of the used container. The emptied container is brought in a verifiable manner into a secure-access region 41. If required, the empty containers are exchanged in a verifiable manner for full containers by the security provider 38. During the production process, production-relevant data, such as the number of security features issued, the volume and/or mass in the case of a marking medium, the number of security features not completely applied, security features not detected or not applied, faults when changing the containers, the number of containers changed, the number of security features issued per container and/or control pulses of the detected articles on which a deposit is to be charged, are saved directly on a memory system integrated in the container. The same data is also deposited in the data-processing system 24 at the filler 36. By means of data transmission 48, this production data goes to the security provider 38 and flows into the EDP-based management system 44. As soon as the container with the same dataset has arrived at the security provider 38, this dataset is also assigned to the appropriate container the EDP-based management system 44. A plausibility check 49 is then carried out, by the use of which the items of data are compared with one another. A plausibility check is carried out in order to check the number of security features issued, such as premature shutdown and complete application of the marking and also faults during operation.

The data stored and logged in the data-processing system 24 is sent to the clearing authority (designation 51). The security provider coordinates his data with the clearing authority 37 (designation 52). This makes it possible to ensure that the containers with marking medium are in a continuously secured circuit. As a result, no marking medium can be removed as a result of a third-party intervention, nor can a removal without a marking actually having been carried out be simulated. By means of the EDP-based management system 44, the traceability of the containers is ensured, which likewise permits the plausibility check 49, for this purpose the data from two data sources being used and evaluated by specific algorithms.

1. A method for producing a returnable package having at least one deposit mark, in which a recyclable object on which a deposit is to be charged is provided with at least one first, irremovable security feature in which at least one further irremovable security feature is applied to the object on which a deposit is to be charged and which is provided with at least one first security feature before, during and/or after the introduction of goods into the object on which a deposit is to be charged, the issue of said security feature being predefined by a control system that is not accessible to the manufacturer of the returnable package, and in which the deposit value of the deposit mark is generated by means of the combination of the at least one first and further security feature.

2. The method as claimed in claim 1, characterized in that, by means of the at least one first and further security feature at least one item of information for detecting the authenticity of the returnable package for a material circulation system is applied.

3. The method as claimed in claim 1, characterized in that, by means of the at least one first and further security feature, at least one item of information for detecting the amount of the deposit is applied.

4. The method as claimed in claim 1, characterized in that at least one security feature is formed as an open or visually detectable feature.

5. The method as claimed in claim 4, characterized in that the open security feature is formed as a bar code, imprint of a deposit value, of a deposit logo or information that can be detected by touch.

6. The method as claimed in claim 1, characterized in that at least one security feature is formed as a feature that can be read with aids.

7. The method as claimed in claim 1, characterized in that at least one security feature is formed as a machine-readable feature.

8. The method as claimed in claim 1, characterized in that at least one security feature is at least partly transparent, translucent, phosphorescent, fluorescent, luminescent, UV-emitting and/or IR-emitting.

9. The method as claimed in claim 1, characterized in that at least one security feature comprises substances in the form of Stokes pigments and/or anti-Stokes pigments.

10. The method as claimed in claim 1, characterized in that at least one security feature which fluorescent security pigments with a rapid decay constant is applied.

11. The method as claimed in claim 1, characterized in that the at least one deposit mark is generated from at least one item of open information and/or an item of information that can at least be read with aids and/or by machine.

12. The method according to claim 1, characterized in that the at least one first security feature is issued as a function of the at least one further security feature and vice versa.

13. The method as claimed in claim 1, characterized in that the at least one security feature and the at least one further security feature are formed with at least partly coincident, complementary and/or superimposing items of information.

14. The method as claimed in claim 1, characterized in that at least one security feature is applied directly on or introduced directly in the object on which a deposit is to be charged.

15. The method as claimed in claim 14, characterized in that the at least one further security feature is applied by means of direct printing on at least one part of the object on which a deposit is to be charged.

16. The method as claimed in claim 1, characterized in that at least one security feature is applied indirectly to the object on which a deposit is to be charged.

17. The method as claimed in claim 16, characterized in that the at least one first security feature is applied on labels, closures of containers, can lids, decorative prints or crown corks.

18. The method as claimed in claim 1, characterized in that the at least one further security feature is applied in an inline process of the returnable package.

19. A method of implementing a returnable package system, a returnable package being produced by a method as claimed in claim 1, characterized in that the at least one security feature is applied by the marking unit.

20. The method as claimed in claim 19, characterized in that the at least one further security feature is applied by a marking unit which receives from a control unit a clock pulse which is derived from the conveying speed of the returnable package.

21. The method as claimed in claim 19, characterized in that each issue of a further security feature is passed on to a data-processing system and at least partly stored.

22. The method as claimed in claim 19, characterized in that a reader is used to interrogate the security features.

23. The method as claimed in claim 19, characterized in that a reader is connected after a marking unit in the conveying direction of the object on which a deposit is to be charged, and in that, by means of the reader the at least one further security feature applied is registered and passed on to a data-processing system.

24. The method as claimed in claim 1, characterized in that at least the marking unit for applying the at least one further security feature and the reader are positioned at a short distance from each other.

25. The method as claimed in claim 24, characterized in that the distance between the marking unit and the reader, in particular in a filling plant, is dimensioned to be less than three meters.

26. The method as claimed in 19, characterized in that the at least one further security feature is applied without contact to the object on which a deposit is to be charged.

27. The method as claimed in 19, characterized in that the at least one further security feature is applied by the marking unit by means of a marking medium having security pigments.

28. The method as claimed in 19, characterized in that the number, the volume and/or the mass of the security features applied is stored in a memory element arranged in a container accommodating the marking medium.

29. The method as claimed in claim 19, characterized in that the number, the volume and/or the mass of the security features applied is stored in a data-processing system.

30. The method as claimed in claim 19, characterized in that a code is assigned to the container accommodating the marking medium for forming the at least one further security feature.

31. The method as claimed in one of claims 19 to 30, characterized in that, when the empty containers are replaced by full containers, data from the data-processing system is transmitted from a filler to a clearing authority.

32. The method as claimed in claim 19, characterized in that, when the empty containers are replaced by full containers, data from the data-processing system is transmitted to a security provider.

33. The method as claimed in claim 19, characterized in that the data in the memory element of the containers returned to the security provider is read and checked by the security provider.

34. The method as claimed in claim 19, characterized in that a requirement for full containers for the marking medium from the filler and/or the requested number of full containers for the marking medium from the filler are registered and stored by a security provider.

35. The method as claimed in claim 28, characterized in that at least the data transmitted directly by the filler and at least the data passed on by the filler to a clearing authority are checked by a security provider by means of a plausibility check.

36. The method as claimed in claim 35, characterized in that the plausibility check is carried out by an EDP-based management system.

37. The method as claimed in claim 35, characterized in that, during the plausibility check, the number of further security features issued and/or the volume and/or mass of the marking medium produced and filled into containers, the production of the containers and/or the identification and/or the number of control pulses from a control unit for driving the marking unit are checked.

38. A returnable package having at least one deposit mark which is produced by a method in which a recyclable object on which a deposit is to be charged is provided with at least one first, irremovable security feature, in which at least one further irremovable security feature is applied to the object on which a deposit is to be charged and which is provided with at least one first security feature, before, during and/or after the introduction of goods into the object on which a deposit is to be charged, the issue of said security feature being predefined by a control system that is not accessible to the manufacturer of the returnable package, and in which the deposit value of the deposit mark is generated by means of the combination of the at least one first and further security feature.
